(19) United States
(12) Patent Application Publication
(10) Pub. No.: US 2005/0098577 A1
(43) Pub. Date: May 12, 2005

(54) Hand-crankable water guns

(76) Inventors: Gerhart P. Huy, Hamilton Square, NJ (US); Anthony J. Wyzen, Elkton, MD (US); Burton C. Trattner, Hamburg, NJ (US); John David McBride JR., Morton, PA (US); Truman John Gilbert, Philadelphia, PA (US)

Correspondence Address: KOLISCH HARTWELL, P.C., 520 S.W. YAMHILL STREET, SUITE 200, PORTLAND, OR, 97204, US

(21) Appl. No.: 10/836,647

(22) Filed: Apr. 30, 2004

Related U.S. Application Data
(60) Provisional application No. 60/467,221, filed on May 1, 2003.

(51) Int. Cl. B05B 12/10

(52) U.S. Cl. 222/79

(57) ABSTRACT

Embodiments of a water gun are provided, which may include a body, further including a reservoir for holding a fluid, a nozzle for ejecting fluid, and a shield mounted to the body; a pump assembly operable to move fluid from the reservoir to the nozzle, and a hand-operated crank assembly rotatably coupled to the body. Rotation of the crank assembly may operate the pump assembly to eject fluid from the water gun. In some embodiments, the shield is pivotably or foldably mounted to the body and may be retained in one or more selected positions perpendicular or parallel to the body of the water gun, which may allow a user to deflect fluid streams ejected from other water guns. In some embodiments, a plurality of nozzles is provided, each of which may be selectively operated exclusive of the other nozzles or in combination with other nozzles.

### CROSS-REFERENCES

The present U.S. patent application claims the benefit of priority under 35 U.S.C. § 120 to U.S. Design patent application Ser. No. 29/180,808, filed Apr. 30, 2003 and entitled “Water Guns” and U.S. Provisional Patent Application Ser. No. 60/467,221, filed May 1, 2003 and entitled “Hand Crankable Water Guns,” both of which are incorporated herein by reference in their entirety for all purposes.

### BACKGROUND

The present disclosure relates generally to water guns and, more particularly, to a water gun with a shield mounted thereon, in which water is propelled from one or more nozzles by operation of a hand crankable pump.

Examples of water guns with pistons to propel predetermined spurts of water, a pressure vessel which could be filled with water and pressurized, and rotary pumps to eject either individual spurts or continuous streams of water, are disclosed in U.S. Pat. Nos. 2,888,172, 3,022,779, 4,441,629, 4,591,071, 5,074,437, 5,292,032, 5,318,202, 5,779,100, 5,913,304, 6,138,871, 6,408,837, 6,474,507, and 6,540,108. Examples of water guns with shields are disclosed in U.S. Pat. Nos. 5,435,569 and 5,611,460. Examples of water guns with rotary pumps are disclosed in U.S. Pat. No. 5,730,325. The disclosures of these and all other publications referenced herein are incorporated by reference in their entirety for all purposes.

### SUMMARY OF THE DISCLOSURE

Embodiments of a water gun are provided, which may include a body, further including a reservoir for holding a fluid, a nozzle for ejecting fluid, and a shield mounted to the body; a pump assembly operable to move fluid from the reservoir to the nozzle, and a hand-operated crank assembly rotatably coupled to the body. Rotation of the crank assembly may operate the pump assembly to eject fluid from the water gun. In some embodiments, the shield is pivotably or foldably mounted to the body and may be retained in one or more selected positions perpendicular or parallel to the body of the water gun, which may allow a user to deflect fluid streams ejected from other water guns. In some embodiments, a plurality of nozzles is provided, each of which may be selectively operated exclusive of the other nozzles or in combination with other nozzles.

### BRIEF DESCRIPTION OF THE DRAWINGS

FIG. 1 is a front perspective view of an embodiment of a hand crankable water gun with a shield and a plurality of nozzles, wherein the shield is shown folded to a position substantially perpendicular to the water gun.

FIGS. 2A and 2B are detail elevation views of the shield and shield mount components of the water gun of FIG. 1, illustrating how the shield is attached to the shield mount.

FIG. 3 is a cross-sectional view along the line 3-3 of FIG. 2B, illustrating how the shield may be retained in a selected position.

FIG. 4 is a detail perspective view of part of the shield and body of the water gun of FIG. 1, illustrating how the shield may be retained against the body.

FIG. 5 is a schematic cross-sectional view of the interior of the water gun of FIG. 1, illustrating an exemplary configuration of components of a pump assembly including a peristaltic pump mechanism.

FIG. 6 is a cross-sectional view of the inlet and cap assembly of the water gun of FIG. 1.

FIG. 7 is an exploded perspective view of components of the peristaltic pump mechanism of FIG. 5 and some exemplary components of the crank assembly of the water gun of FIG. 1.

FIG. 8 is a second schematic cross-sectional view of the interior of the water gun of FIG. 1, illustrating an exemplary configuration of components of a pump assembly including a gear pump mechanism.

FIG. 9 is a front perspective view of a second embodiment of a hand crankable water gun with a shield and a plurality of nozzles, wherein the shield is shown folded to a position substantially perpendicular to the water gun.

FIG. 10A is a rear perspective view of the water gun of FIG. 9, shown with the shield folded to a position substantially parallel to the water gun.

FIG. 10B is a rear elevation view of the water gun of FIG. 9, shown with the shield folded to a position substantially perpendicular to the water gun, and rotated to three different positions relative to a vertical plane of the water gun.

FIG. 11 is a cross-sectional view of exemplary components of the shield, shield mount, and body of the water gun of FIG. 9, illustrating how the shield may be rotated to the positions depicted in FIG. 10B.

FIG. 12 is an exploded elevation view of exemplary components of the nozzle assembly and body of the water gun of FIG. 9.

FIG. 13 is a front perspective view of a third embodiment of a hand crankable water gun with a shield and a plurality of nozzles, wherein the shield is integral with the body of the water gun.

### DETAILED DESCRIPTION

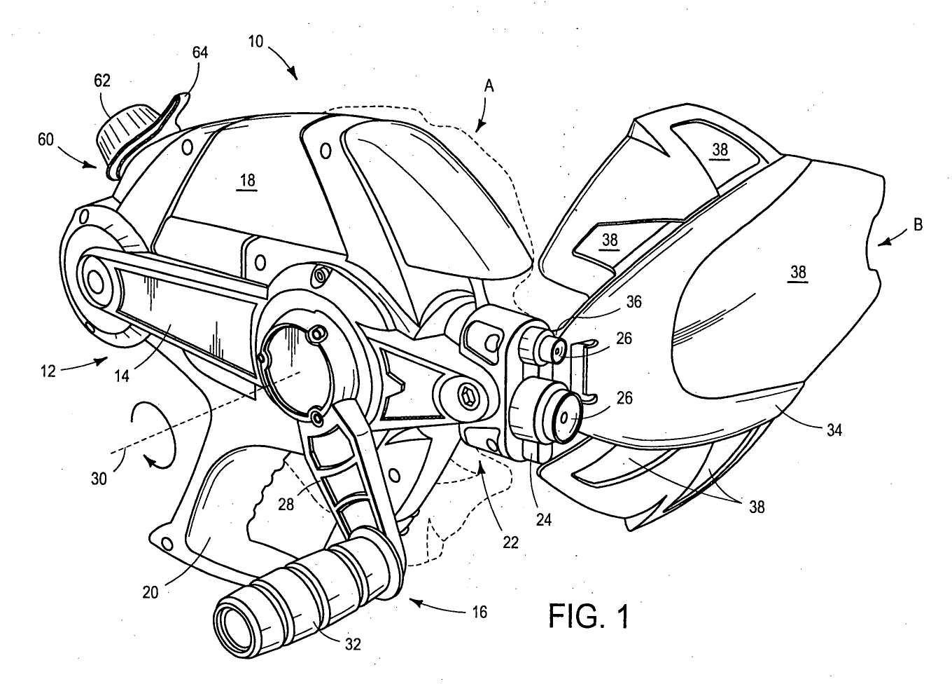

One embodiment of a hand crankable water gun is indicated at 10 in FIG. 1. Water gun 10 may include a body 12 having a housing 14, which may be shaped to provide gun 10 with a futuristic design. A crank assembly 16 may extend from one side of housing 14. A reservoir 18, adapted to hold a fluid such as water, may be mounted to body 12, and secured by part of housing 14. Body 12 may also include a hand grip 20 and a nozzle portion 22, which may further include a nozzle mount 24 having one or more nozzles 26 disposed thereon.

Crank assembly 16 may be rotatably operable to move water from reservoir 18 through nozzles 26. Thus, crank assembly 14 may be operated by a user, such as by rotating a crank arm 28 about an axis 30 by gripping a crank handle 32 with one hand, issuing streams or spurts of water from nozzles 26. Hand grip 20 may be adapted to allow a user to hold gun 10 with the other hand.

Body 12 may optionally include a shield 34, mounted to housing 14 on a shield mount 36. Shield mount 36 may be configured to hingedly couple shield 34 to body 12 such that shield 34 may be selectively retained in a folded-in position substantially parallel to body 12 (indicated in dashed lines in FIG. 1 and designated as “A”), or folded outward from body 12 and selectively retained in an extended position substantially perpendicular to body 12 (indicated in solid lines in FIG. 1 and designated as “B”). Thus, a user of gun 10 may retain shield 34 in extended position B, such as to deflect streams of water from other water guns. So that a user's visual range is not impaired when shield 34 is extended, the shield may include a plurality of transparent windows 38.

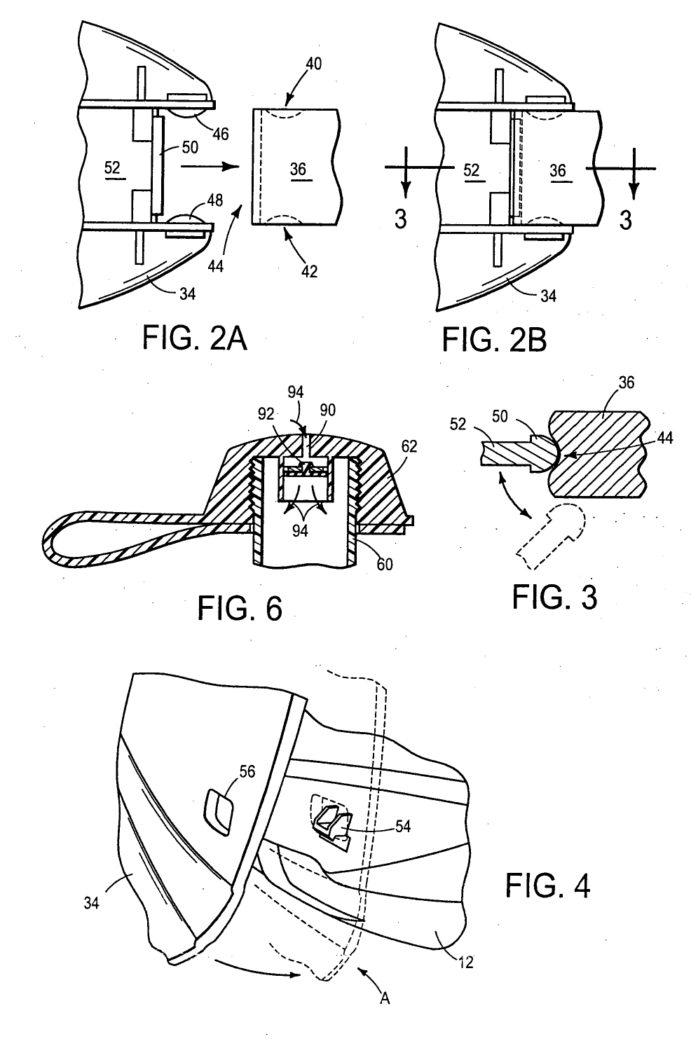

FIGS. 2A and 2B show detail views of an exemplary configuration by which shield 34 may be coupled to body 12 by shield mount 36. FIG. 2A shows that a pair of opposing divots 40, 42 may be disposed on the top and the bottom of shield mount 36, and a groove 44 may be disposed vertically on one side of shield mount 36. The opposite side of shield mount 36 may join body 12 (not shown in this view).

FIG. 2A also shows that shield 34 may have a pair of opposing posts 46, 48, and a vertical strut 50. A bracing portion 52 may provide structural support to strut 50. As can also be seen in FIG. 2B, posts 46, 48 may be shaped and positioned to fit within divots 40, 42 on shield mount 36, to form a hinge mechanism, and strut 50 may be shaped and positioned to be received within groove 44 of shield mount 36.

Shield 34 may be pivoted about posts 46, 48 and selectively retained in place by the configuration of groove 44 and strut 50. Specifically, FIG. 3 shows a cross-sectional view that shows strut 50 engaging groove 44, which may retain shield 34 in position B (that is, substantially perpendicular to body 12). Pivoting shield 34 may disengage strut 50 from groove 44, as shown in dashed structure in FIG. 3, for example, so that shield 34 may be folded back to position A.

Shield mount 36 may be shaped to retain shield 34 in more positions than shown in FIG. 3, for example, if more grooves were provided. Optionally, the shield mount may have teeth, detents, or similar engagement mechanisms to receive a corresponding strut or similar structure on the shield, to retain the shield in selected positions.

In addition to the configuration of the shield mount, body 12 may also have structural features such as retaining devices, clips, and the like, adapted to selectively retain shield 34 folded against body 12 in position A. For example, FIG. 4 shows a detail view of body 12, which may include an outwardly extending tab 54 configured to engage a corresponding slot 56 in shield 34. When so engaged, shield 34 may be “locked” in position A, such as for storage of gun 10, or for operation of gun 10 without shield 34.

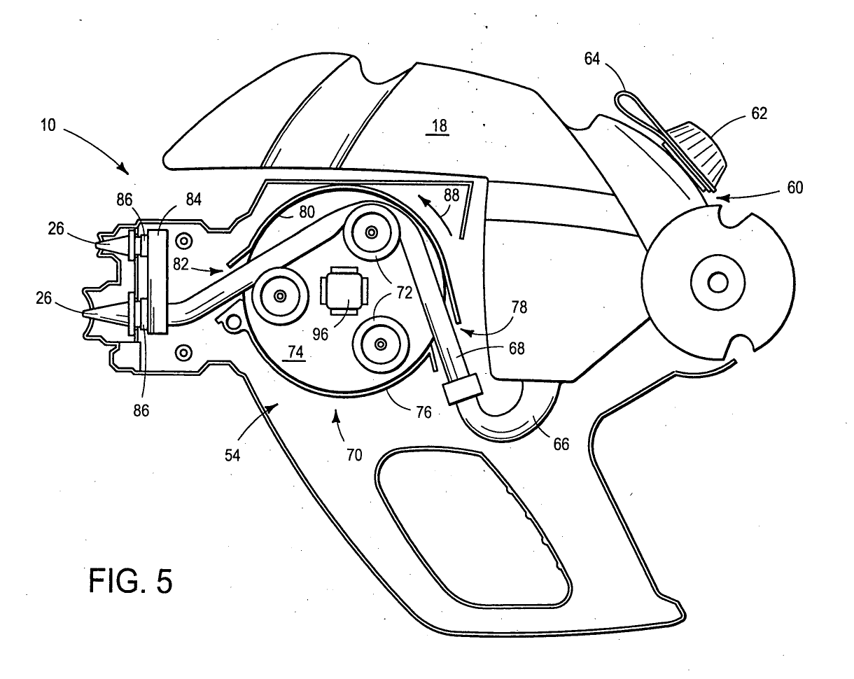

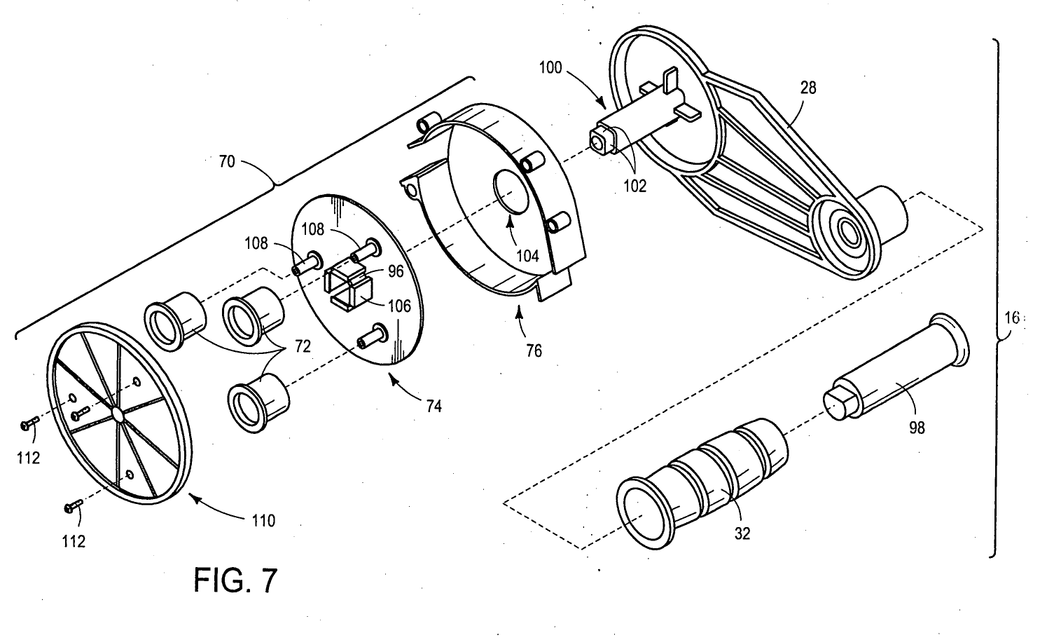

Gun 10 may be adapted to be operable by a user to issue water from nozzles 26 without regard to the position of shield 34. Water from the reservoir may be moved through the nozzles by means of a pump assembly, coupled to the crank assembly and disposed within the housing. For example, FIG. 5 shows a schematic cross-section of water gun 10, illustrating exemplary components of a pump assembly 58. As can also be seen in FIG. 1, reservoir 18 may include an inlet 60 fitted with a cap 62, which may be retained by a tether 64. FIG. 4 shows that reservoir 18 may also include an outlet 66 coupled by a length of hose 68 to pump assembly 58, which may include a pump mechanism 70.

Pump mechanism 70 may be configured as a peristaltic pump, which may include rollers 72 disposed on a roller plate 74 within a pump housing 76. A peristaltic pump may be configured such that no pump components come into contact with fluid moving through the pump. Thus, hose 68 may pass through a first aperture 78 in pump housing 76 into pump mechanism 70, along an inner wall 80 of pump housing 76, and out from pump mechanism 70 through a second aperture 82. Hose 68 may continue to a manifold 84, which may be coupled to nozzles 26 via conduits 86.

Pump mechanism 70 may move water from reservoir 18 through nozzles 26 by rotation of roller plate 74 within pump housing 76. As roller plate 74 rotates, rollers 72 may squeeze hose 68 against inner wall 80, urging water within hose 68 generally in the direction of the rotation of roller plate 74, as indicated by arrow 88. Water urged along within hose 68 towards nozzles 26 also may create a partial vacuum within the hose, which may draw more water from reservoir 18 into the hose.

Reservoir 18 and/or cap 62 may be configured to be effectively open to atmospheric pressure so that movement of water from reservoir 18 will not create a partial vacuum in the reservoir, since such a vacuum may interfere with fluid movement through the pump mechanism. FIG. 6 shows that cap 62 may include a weep hole 90 and a valve assembly 92, to allow the flow of air (indicated by arrows 94) through cap 62. FIG. 6 also shows that cap 62 may thread onto inlet 60, but other embodiments or may include other configurations such as snap-on and/or plug in closures.

As mentioned above, operation of the pump assembly may be accomplished with the crank assembly. For example, the crank assembly may be coupled to a part of the pump mechanism, such as roller plate 74, through a crank shaft opening 96. As explained in greater detail below, such an arrangement may allow rotational energy from operation of the crank assembly to be translated into rotational motion of roller plate 74.

FIG. 7 depicts an isometric, exploded view of exemplary components of crank assembly 16 and pump mechanism 70 to more clearly illustrate one configuration by which the crank assembly may be operably coupled to the pump assembly. In FIG. 7, crank assembly can be seen to include a crank handle 32 disposed on an inner handle member 98 and coupled to crank arm 28. Crank arm 28 may include a crank shaft 100 with four flat sides 102, such that crank shaft 100 has a generally square-shaped cross-section.

Crank shaft 100 may extend into the housing (not shown in this view), through a hole 104 in pump housing 76, and into crank shaft opening 96 in roller plate 74. Roller plate 74 may include a plurality of braces 106 to engage flat sides 102 of crank shaft 100, stabilizing the crank shaft with respect to the roller plate. Roller plate 74 may optionally include a plurality of roller shafts 108 to allow rollers 72 to rotate with respect to roller plate 74. Roller shafts 108 may be hollow to allow a pump housing cover 110 to be fastened to roller plate 74, such as by a plurality of screws 112 or other fasteners, to secure a hose (not shown in this view) in position within pump housing 76.

As illustrated in the exemplary embodiments above described above, pump mechanism 70 may be coupled directly to the crank assembly such that roller plate 74 rotates generally coaxially with crank assembly 16, in substantially the same direction, and at a similar rate. Other embodiments may include structural variations such as a differential gear assembly, drive trains, and the like, to impart different rotational speeds to roller plate 74, to dispose a drive shaft eccentrically with respect to the axis of rotation of roller plate 74, to allow fluid movement from the reservoir through the nozzles without regard to direction of rotational movement of the crank assembly, and so forth.

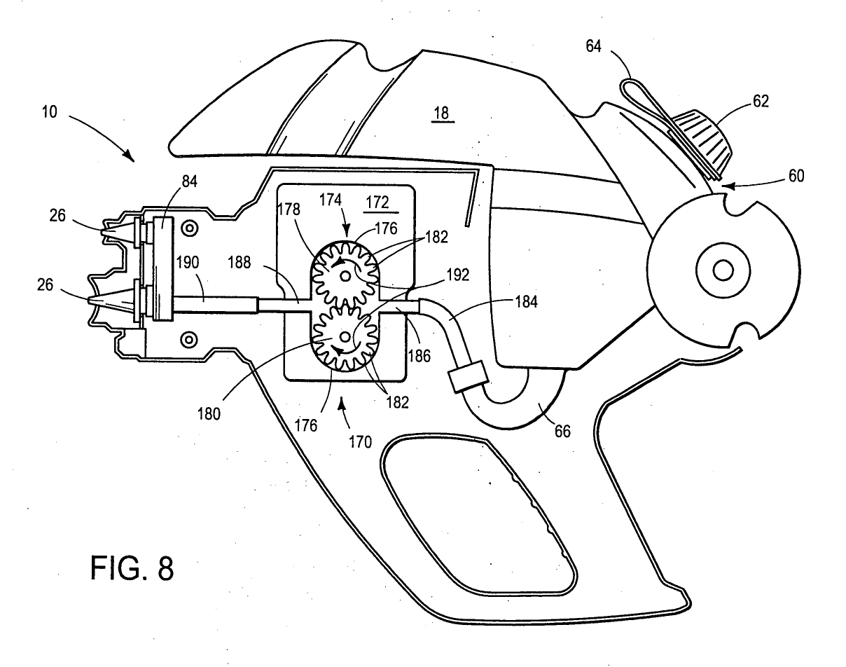

Further, although the pump mechanism illustrated in FIGS. 6 and 7 is a peristaltic type of pump, various other styles of pump mechanisms are capable of being operated by a rotating crank assembly to move water from the reservoir through the nozzles. For example, FIG. 8 shows a schematic cross-section of water gun 10, illustrating another configuration of components of a pump assembly including a gear pump mechanism (indicated as pump mechanism 170 to indicate the presence of components which may not be included in pump mechanism 70).

Pump mechanism 170 may include a pump housing 172 having an elongated chamber 174 with semicircular inner walls 176, within which is supported a pair of gears 178, 180, intermeshed by a plurality of gear teeth 182. A pump housing cover (not shown) may be secured to pump housing 172, enclosing chamber 174 and sandwiching gears 178, 180 between the pump housing and the pump housing cover. Reservoir 18 may be coupled by a length of hose 184 to a fluid inlet 186 of pump housing 172. A fluid outlet 188, disposed opposite fluid inlet 186, may be coupled by a second length of hose 190 to manifold 84.

Pump mechanism 170 may move water from reservoir 18 through nozzles 26 by rotation of gears 178, 180 within pump housing 172. Rotation of the gears in the direction indicated by arrows 192 may mesh the gear teeth on the outlet side of chamber and unmesh the gear teeth on the inlet side. Unmeshing of gear teeth 182 on the inlet side of chamber 174 may create a partial vacuum the chamber, drawing water into pump housing 172. At the same time, meshing of gear teeth 182 on the outlet side may correspondingly produce pressure sufficient to force water out of chamber 174 through outlet 188. Water may thus flow from the inlet to the outlet by being urged along inner walls 176 by gear teeth 182. The amount of fluid moved through pump mechanism 170 may thus relate to the rotational speed of gears 178, 180.

Further, the efficiency of the pump mechanism may be improved by maintaining close tolerances among the various components, which may reduce fluid recirculation back from the high-pressure outlet side of the chamber to the low-pressure inlet side of the chamber.

As with the peristaltic pump configuration of pump mechanism 70 illustrated in FIGS. 6 and 7, the exemplary gear pump assembly illustrated in FIG. 8 may be operably coupled to the crank assembly. Specifically, the crank assembly may be coupled to a part of gear pump mechanism 170. For example, gear 178 may be driven by crank shaft 100 as described above, connected through an aperture (not shown) in pump housing 172. Optionally, additional structure such as differential gears, gear trains, and the like, may couple the crank assembly to pump mechanism 170 such that gears 178, 180 may rotate at a different rate than the crank assembly.

As will be evident to those skilled in the art, other exemplary embodiments of the water gun disclosed herein may include variations in component configuration, in addition or alternatively to the pump mechanism, and/or variations in component arrangement within a water gun.

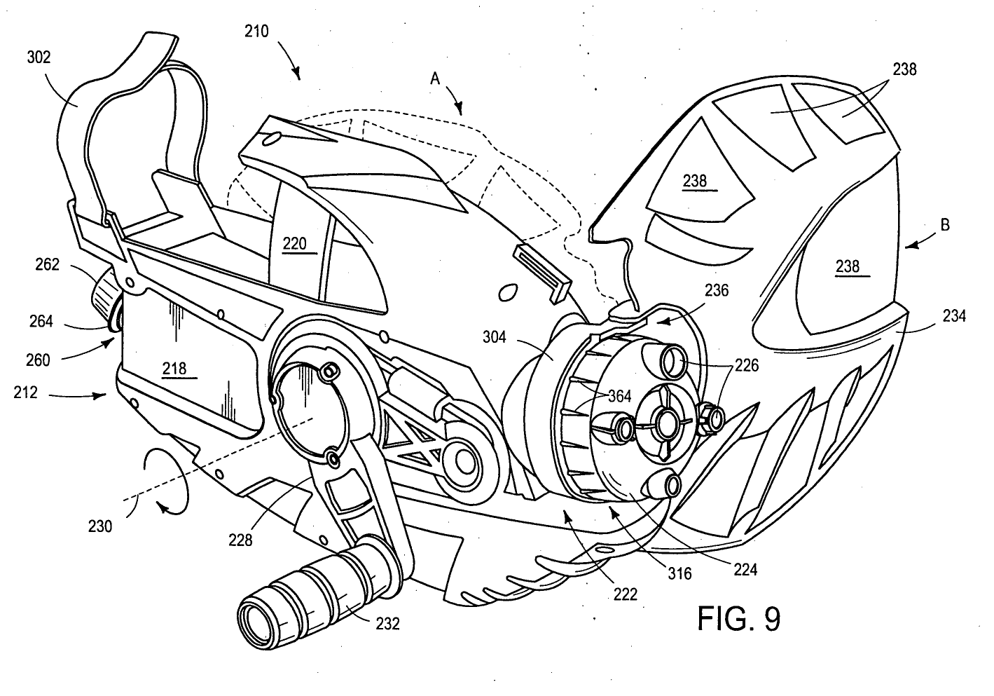

For example, FIG. 9 shows a second embodiment of a hand crankable water gun 210, structurally similar to water gun 10 in that a body 212 may have a housing 214 from which extends a crank assembly 216. Crank assembly 216 may be operable to move water from a reservoir 218 through one or more nozzles 226 on a nozzle mount 224. Reservoir 218 may include an inlet 260, upon which may be fastened a cap 262, which may be secured with a tether 264. Gun 210 may also include a hand grip 220 and a shield 234 hingedly coupled to body 212 by shield mount 236.

Gun 210 may also be operationally similar to gun 10 in that crank assembly 218 may be coupled to a pump assembly disposed within housing 214, operable by rotation of a crank arm 228 about an axis 230, for example, by a user gripping a crank handle 232. Shield 234 may also be retained in a position “A” substantially parallel to body 212 (indicated in dashed lines in FIG. 9) or retained in an extended position “B” substantially perpendicular to body 212 (indicated in solid lines in FIG. 9).

However, several components of gun 210 may differ from those shown in FIGS. 1-8, which depict exemplary components of gun 10. For example, the pump assembly of gun 210 may include a pump mechanism, such as a peristaltic pump or a gear pump as described in detail above in gun 10, or a different type of pump. Also, as can be seen in FIG. 8, reservoir 218 may be positioned near the bottom of body 212, whereas hand grip 220 may disposed near the top. Additionally, body 212 may further include a strap 302, for example to receive a user's forearm, stabilizing a user's grip of gun 210.

In addition, shield mount 236 may include a collar or yoke 304, rotatably connected to a nozzle portion 222 such that when shield 234 is retained in an extended position substantially perpendicular to body 212, rotation of yoke 304 may also rotate shield mount 236 and extended shield 234, for example about nozzle portion 222. Thus, shield mount 236 (and shield 234) may be rotated and selectively retained in any of a plurality of predetermined positions with respect to body 212.

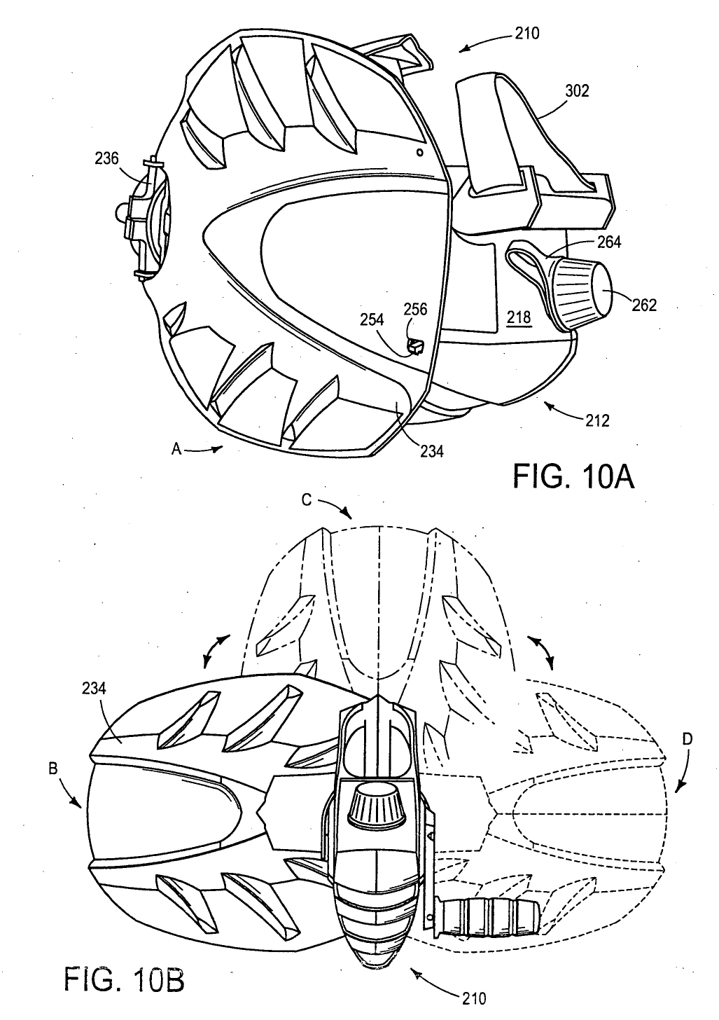

For example, FIG. 10A depicts gun 210 with shield 234 adjacent to body 212 in folded-in position A, retained by a tab 254 on body 212 engaging a slot 256 on shield 234. FIG. 10B shows shield 234 pivoted and selectively retained in an extended position B to one side of body 212 (indicated in solid structure). FIG. 10B also shows shield 234 rotated and selectively retained in a third position “C” so that it extends generally upwardly from body 212 (indicated in a first set of dashed lines) and rotated and selectively retained in a fourth position “D” so that it extends generally to the opposite side of body 212 (indicated in a second set of dashed lines).

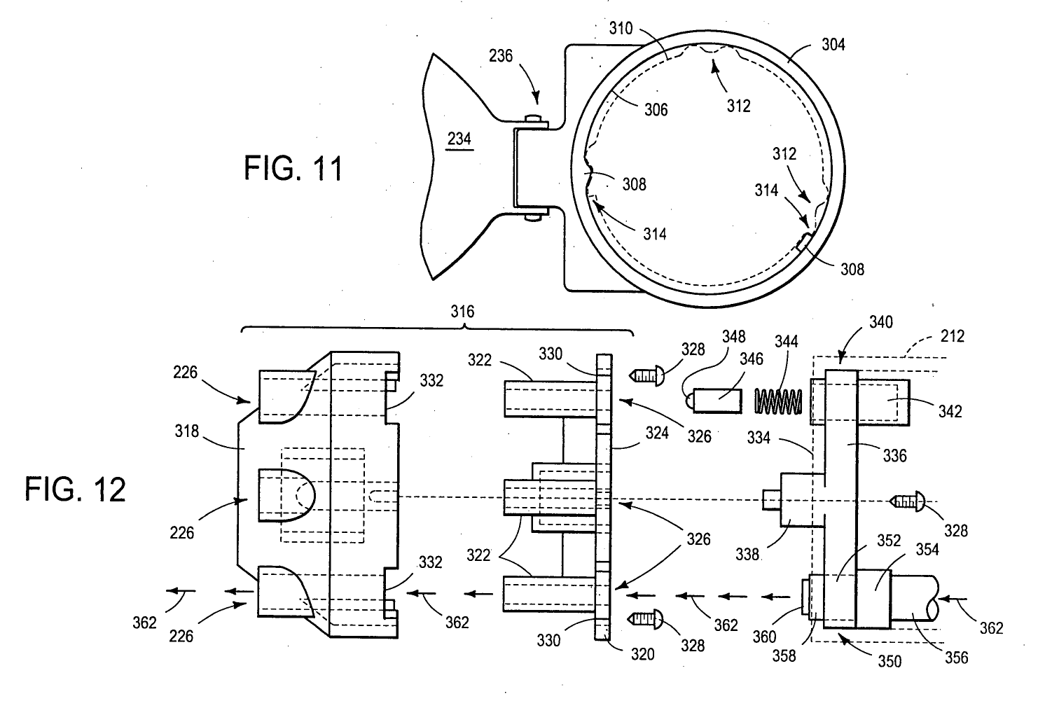

An exemplary configuration of yoke 304 adapted to selectively retain shield mount 236 in predetermined positions such as B, C, and D is shown in FIG. 11. Yoke 304 may include an interior surface 306 having retention devices 308 disposed thereon, which may adapted to slide within a channel 310 peripherally disposed on a nozzle portion 222 of body 212. Channel 310 may include corresponding structural elements such one or more detent portions 312 and one or more stops 314, disposed within channel 314. Thus, when yoke 304 is rotated around channel 310, retention devices 308 may engage detent portions 312, selectively retaining yoke 304 (and shield mount 236) in a corresponding position. Retention devices 308 may also engage stops 314, which may be configured to prevent further rotation of yoke 304 in a given direction. In some embodiments, yoke 304 may be configured to rotate to more or fewer predetermined positions than those shown in FIGS. 10A and 10B. In some embodiments, yoke 304 may be configured to rotate fully around nozzle portion 222.

Referring again to FIG. 9, it can be seen that nozzle mount 224 may also be configured differently in gun 210 than in gun 10. For example, nozzle mount 224 may further include a rotatable turret 316 upon which nozzles 226 are disposed. Turret 316 may be configured to allow selection of one or more nozzles 226, such as by a user of gun 210. For example, FIG. 12 depicts exemplary components of turret 316 and related structural components of gun 2.10 to illustrate nozzle selection.

As seen in FIG. 12, turret 316 may include a substantially cone-shaped turret housing 318 upon which nozzles 226 may be disposed. Turret 316 may also include a turret base 320 from which a plurality of hollow flow tubes 322 extend. Flow tubes 322 may correspond in number, position, and configuration to nozzles 226 such that when turret base 320 is attached to turret housing 318, each flow tube 322 may or fit within, or other wise couple to, a nozzle 226. Flow tubes 322 may terminate on a flat side 324 of turret base 320 in a plurality of flow holes 326.

Flat side 324 may further include a plurality of apertures (not separately numbers) adapted to receive fasteners or screws 328 to attach the turret base to turret housing 318. Other structural features such as radially disposed tabs 330 on turret base 320 may mate with corresponding slots 332 of turret housing 318, properly aligning flow tubes 322 with nozzles 226.

Flat side 324 of turret base 320 may abut, and/or be rotatably attached to, a flat nose portion 334 of body 212 by means of a brace 336 disposed substantially within body 212. Portions of brace 336 may protrude from nose portion 334 to contact turret 316. For example, brace 336 may include a central boss 338, shaped to protrude from nose portion 334 into turret base 320, and may be adapted to hold turret 316 against the nose portion with a screw 328 or other suitable fastening device.

A top end 340 of brace 336 may have a recess 342 in which a spring 344 is disposed, which may urge a peg 346 to protrude from nose portion 334 outwardly from the recess. Peg 346 may have a hemispherical end 348 sized to fit within each of flow holes 326. Brace 336 may further include a bottom end 350 through which a hollow channel 352 extends. One end of channel 352, disposed within nose portion 334 may include a collar 354 coupled to tubing 356. A support 358 for an O-ring 360 may be placed at the other end of channel 352. O-ring 360 may protrude from nose portion 334 and may be sized and shaped to form a seal between channel 352 and one of flow holes 326.

Turret 316 may thus be rotated against nose portion 334. As turret 316 is rotated, flat side 324 may correspondingly move against peg 348 and O-ring 360. When one of flow holes 326 is aligned with O-ring 360, peg 346 may snap forward, engaging a flow hole opposite the flow hole aligned with the O-ring, selectively retaining the turret in the selected position. Further rotation of turret 316 may disengage peg 346 by urging hemispherical end 348 out of the flow hole and pushing peg 348 back into the recess, from which it may snap forward again if O-ring 360 is aligned with another flow hole. Thus, this configuration may allow selective alignment of one of nozzles 226 with tubing 356. When so aligned, water from the pump assembly may move through tubing 356, through a given flow tube 326, and through a given nozzle 226 corresponding to the flow tube, for example, as indicated by the arrows 362. Thus, a user may determine from which of nozzles 226 water is propelled, upon operation of the crank assembly.

Turret 316 may include additional features such as a plurality of knurls 364 disposed on turret housing 316 (as can be seen in FIG. 9), for example to assist rotation by providing a gripping surface. Further, the amusement value provided by gun 210 may be enhanced by providing different nozzle configurations from which to choose. For example, each nozzle 226 may be provided with a different size and/or number of apertures, and/or other structural features which may affect characteristics of a water stream ejected from a nozzle such as volume of water ejected, range, accuracy, and so forth.

From the above description it is clear that other embodiments may include variations in the structure and configuration of the turret. Such variations may include more or fewer nozzles, configurations to allow a user to choose to propel water from more than one nozzle simultaneously, and/or other retention devices by which one or more nozzles may be held in proper alignment to allow water to move from the pump assembly to the nozzles.

Optionally, other embodiments may be configured to allow selection of one or more nozzles by means in addition or alternatively to a turret. For example, some embodiments may include a plurality of nozzles in the form of conventional push/pull valves, or threaded on internal valve members, and so forth.

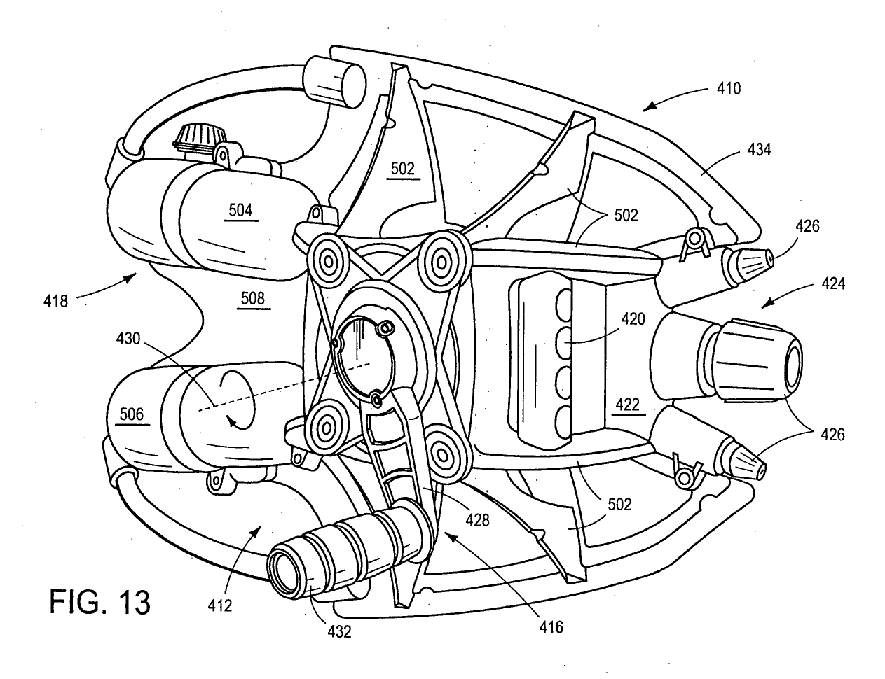

FIG. 13 shows a third embodiment of a hand crankable water gun 410, structurally similar to water guns 10 and 210 in that a body 412 may have a housing 414 from which extends a crank assembly 416. Crank assembly 416 may be operable to move water from a reservoir 418 through one or more nozzles 426 on a nozzle mount 424. Gun 410 may also include a hand grip 420.

Gun 410 may also be operationally similar to guns 10 and 210 in that crank assembly 416 may be coupled to a pump assembly disposed within housing 414, operable by rotation of a crank arm 428 about an axis 430 by a user gripping a crank handle 432. Further, the pump assembly of gun 410 may include a pump mechanism, such as a peristaltic pump or a gear pump as described in detail above in gun 10, or a different type of pump.

However, several components of gun 410 may differ from those shown in FIGS. 1-12, which depict exemplary components of guns 10 and 210. For example, as can be seen in FIG. 13, shield 434 may be mounted integrally with body 412, and may further be spaced away from housing 414 by a plurality of ribs 502. Also, reservoir 418 may include two bullet-shaped portions 504, 506, coupled by a shallow portion 508. The arrangement of portions 504, 506, and 508 of reservoir 418 may extend the curve and shape of shield 434.

Further, hand grip 420 may be disposed between housing 414 and shield 434. This configuration may allow gun 410 to be worn in a manner similar to that of a traditional shield; that is, on the forearm of a user reaching between shield 434 and housing 414 and grasping hand grip 420.

Gun 410 may further include a nozzle portion 422 mounted on shield 434, as opposed to being mounted on the body, as illustrated in the exemplary embodiments discussed above. The design of the nozzle portion may further continue the curve and shape of shield 434, if, for example, a nozzle mount 424, and nozzles 426, are disposed at the tip or apex point of the shield.

Nozzles 426, and reservoir 418, may be coupled to a pump mechanism of gun 410 by means of lengths of flexible tubing or hose (not shown), disposed within ribs 502, to allow water to be moved from reservoir 418 and out of nozzles 426 in a manner similar to that disclosed above in guns 10 and 210. Further, nozzles 426 may be configured to eject water simultaneously, exclusively, or in some combination as determined by a user of gun 410.

While the inventions defined in the following claims have been particularly shown and described with reference to the foregoing examples, those skilled in the art will understand that many variations may be made therein without departing from the spirit and scope of the inventions. Other combinations and sub-combinations of features, functions, elements, component, actions, and/or properties may be claimed through amendment of the present claims or presentation of new claims in this or a related application. Such amended or new claims, whether they are directed to different combinations or directed to the same combinations, whether different, broader, narrower or equal in scope to the original claims, are also regarded as included within the subject matter of the present disclosure.

The foregoing embodiments are illustrative, and no single feature, component, or action is essential to all possible combinations that may be claimed in this or later applications. Where the claims recite “a” or “a first” element or the equivalent thereof, such claims should be understood to include one or more such elements, neither requiring nor excluding two or more such elements. Further, cardinal indicators, such as first, second, and third, for identified elements or actions are used to distinguish between the elements and actions, and do not indicate a required or limited number of such elements or actions, nor does it indicate a particular position or order of such elements or actions unless otherwise specifically stated.

1. A water gun, comprising:
a body, further including:
a shield mounted to the body;
a reservoir for holding a fluid; and
a nozzle for ejecting fluid from the water gun;
a pump assembly operable to move fluid from the reservoir to the nozzle; and
a crank assembly rotatably coupled to the body;
wherein rotation of the crank assembly operates the pump assembly.

2. The water gun of claim 1 wherein the pump assembly includes one or more of a peristaltic pump and a gear pump.

3. The water gun of claim 1 wherein the body includes one or more of a hand grip and a forearm strap.

4. The water gun of claim 1 wherein the reservoir includes:
an inlet; and
a cap adapted to prevent fluid flow from the reservoir through the inlet;
wherein the cap includes means to allow air to move through the cap.

5. The water gun of claim 1, wherein the shield is foldably mounted on the body such that the shield is foldable between a first position in which the shield is substantially parallel to a long axis of the body, and a second position in which the shield is substantially perpendicular to the long axis of the body.

6. The water gun of claim 1 wherein the body further includes a shield mount, and wherein the shield is pivotably attached to the shield mount.

7. The water gun of claim 1 wherein the shield mount is adapted to selectively retain the shield in one or more of a plurality of predetermined positions, including a first position in which the shield is substantially parallel to a long axis of the body and a second position in which the shield is substantially perpendicular to a long axis of the body.

8. The water gun of claim 7 wherein the shield mount further includes a yoke rotatably coupled to the body.

9. The water gun of claim 8 wherein the yoke is adapted to selectively retain the shield mount in one or more of a plurality of predetermined positions when the shield is retained in the first position.

10. The water gun of claim 1, wherein the shield is integrally mounted to the body.

11. The water gun of claim 1 wherein the crank assembly is adapted to be hand-operated.

12. The water gun of claim 1 further including a plurality of nozzles.

13. The water gun of claim 12 wherein each nozzle is adapted to eject fluid independent of each other nozzle.

14. The water gun of claim 12 wherein each nozzle is adapted to eject fluid exclusive of each other nozzle.

15. The water gun of claim 12 wherein the body further includes means for selecting one or more nozzles to eject fluid.

16. The water gun of claim 15 wherein means for selecting one or more nozzles to eject fluid includes a turret rotatably coupled to the body, and wherein rotating the turret selects one or more nozzles.

17. The water gun of claim 15 wherein means for selecting one or more nozzles to eject fluid includes one or more of opening and closing one or more nozzles.

18. The water gun of claim 1 wherein the nozzle is mounted on the shield.

19. The water gun of claim 10 wherein the body further includes a housing; wherein the pump assembly is disposed substantially within the housing; and wherein the shield is spaced away from the housing.

20. The water gun of claim 16, wherein the turret is adapted to rotate relative to the housing, and wherein rotating the turret aligns a nozzle into proper orientation to allow fluid flow from the pump.

21. The water gun of claim 1, further comprising a hand grip defining a generally vertical plane for normal use of the gun, wherein the shield is rotatably mounted on the housing so that the shield may rotate from a normally vertical position in which the shield passes through the vertical plane, to a normally horizontal position in which the shield is substantially to one side of the vertical plane.

22. A water gun, comprising:
a body, including:
a reservoir for holding a fluid; and
a plurality of nozzles for ejecting fluid from the water gun;
a pump assembly operable to move fluid from the reservoir to the nozzle; and
a crank assembly rotatably coupled to the body;
wherein rotation of the crank assembly operates the pump assembly.

23. The water gun of claim 22, further including a shield foldably mounted to the body.

24. The water gun of claim 23 wherein the shield is foldable between a first position in which the shield is substantially parallel to a long axis of the body, and a second position in which the shield is substantially perpendicular to the long axis of the body.

25. The water gun of claim 22 wherein each nozzle is adapted to eject fluid independent of each other nozzle.

26. The water gun of claim 22 wherein each nozzle is adapted to eject fluid exclusive of each other nozzle.

27. The water gun of claim 22 wherein the pump assembly further includes a manifold to move fluid through each of the plurality of nozzles simultaneously.

28. The water gun of claim 22 wherein the body further includes means for selecting one or more nozzles to eject fluid.

29. The water gun of claim 28 wherein means for selecting one or more nozzles to eject fluid includes a turret rotatably coupled to the body, and wherein rotating the turret selects one or more nozzles.

30. The water gun of claim 28 wherein means for selecting one or more nozzles to eject fluid includes one or more of opening and closing one or more nozzles.

31. The water gun of claim 22 wherein the pump assembly includes one or more of a peristaltic pump and a gear pump.

32. A water gun, comprising:
a housing, including:
a reservoir having an inlet and an outlet;
a pump coupled to the reservoir; and
a nozzles coupled to the pump; and
a shield foldably mounted to the body.

33. The water gun of claim 32, wherein the pump includes one or more of a peristaltic pump and a gear pump.

34. The water gun of claim 33, further including a crank assembly operably coupled to the pump, wherein the crank assembly is adapted to be operated by hand.
